(19) United States
(12) Patent Application Publication
(10) Pub. No.: US 2026/0110796 A1
(43) Pub. Date: Apr. 23, 2026

(54) SATELLITE TOMOGRAPHY OF PRECIPITATION AND MOTION VIA SYNTHETIC APERTURE RADAR

(71) Applicant: BAE SYSTEMS Information and Electronic Systems Integration Inc., Nashua, NH (US)

(72) Inventors: Martin F. Ryba, Acton, MA (US); Kevin R. Maschhoff, Wakefield, MA (US)

(73) Assignee: BAE SYSTEMS Information and Electronic Systems Integration Inc., Nashua, NH (US)

(21) Appl. No.: 18/919,529

(22) Filed: Oct. 18, 2024

(51) Int. Cl. G01S 13/90

(52) U.S. Cl. CPC G01S 13/9058; G01S 13/9011; G01S 13/9021

(57) ABSTRACT

A precipitation scanning aperture RADAR system comprises at least one transmitting satellite (TX) and a plurality of receiving satellites (RXs) flying in a multi-static formation. The TX emits fixed frequency, pseudo-random, non-repeating phase modulated RADAR energy. Range and Doppler information is extracted from reflected signals received by the RXs to form coherent 2D along track/vertical images, which are combined into a 3D reflectivity map using a power-based incoherent modeling algorithm, such as a Gaussian mixture model. Embodiments implement a spotlight mode in which, for each RX, a plurality of the coherent 2D images obtained during successive coherent processing intervals (CPIs) are incoherently combined, and the satellites adjust their orientations between each CPI to compensate for satellite movement. Inter-satellite timing synchronization of 10 ns or better is sufficient for forming the 3D reflectivity map. The range and Doppler information can be extracted by concurrently demodulating at a plurality of reference frequencies.

### STATEMENT OF GOVERNMENT INTEREST

This invention was made with government support under Contract No. 80NSSC20K0351 awarded by the National Aeronautics and Space Administration (NASA). The United States Government has certain rights in the invention.

### FIELD OF THE DISCLOSURE

The present disclosure relates to satellite tomography of precipitation and motion thereof, and more particularly to using satellite-implemented synthetic aperture Radio Detection and Ranging (RADAR) to provide a three-dimensional reflectivity map of a storm field at high spatial resolution.

### BACKGROUND OF THE DISCLOSURE

Ground-based precipitation (weather) RADAR data are used for weather monitoring and weather research. However, a major weakness in ground-based weather RADAR is that, because the RADAR transmitters and receivers must be based on land, they are unable to observe storms occurring over much of the earth's surface.

Space-based precipitation RADAR can observe storms anywhere on earth. However, a major weakness of currently deployed space-based precipitation RADAR is that they can only provide relatively coarse (5 km) horizontal resolution, while approximately 1 km resolution is needed to resolve the structure of severe storms and provide meaningful, quantitative precipitation rate information. Theoretically, the horizontal resolution of these space-based RADAR systems could be improved by operating the RADAR at very high frequencies, i.e. in the Ka band or higher. However, such very high frequency RADAR would not be able to resolve the internal structure of a severe storm, because RADAR waves in the Ka band and above would not be able to penetrate into the interior of a severe storm, and would be limited to only detecting the outer boundary of the storm.

Phase-coherent interferometric methods using at least one transmitting satellite and a plurality of receiving satellites have been proposed for improved three-dimensional satellite tomography. However, this approach relies entirely on range measurements by the receiving satellites, and can suffer from 3D model ambiguities in the presence of complex, distributed-target fields, due to difficulties in unambiguously assigning the received, reflected energy to the voxels within the volume being imaged. Furthermore, this approach requires complex, ultra-high precision timing synchronization between the satellites, and is limited to very brief sampling windows, which reduces the signal-to-background-noise and increases the transmitter power requirements.

What is needed, therefore, is a space-based three-dimensional RADAR tomography system that can resolve the internal structure of severe storms and provide meaningful, quantitative precipitation rate information, while minimizing or avoiding 3D model ambiguities, even for complex distributed-target fields, while reducing timing synchronization and transmitter power requirements, and increasing the signal-to- background-noise ratio.

### SUMMARY OF THE DISCLOSURE

The present disclosure is a space-based three-dimensional RADAR tomography system that can resolve the internal structure of severe storms and provide meaningful, quantitative precipitation rate information, while minimizing or avoiding 3D reflectivity field ambiguities, even for complex distributed-target fields, while reducing timing synchronization and transmitter power requirements, and increasing the signal-to-background-noise ratio.

The disclosed system relies on at least one transmitting platform and at least two receiving platforms flying at an altitude that is higher than the altitude of a precipitation field. The platforms fly in a “multi-static” formation, wherein the locations of the platforms relative to each other remain constant. In embodiments, the platforms are orbiting satellites. However, it will be understood that the platforms can also be aircraft, and that the term “satellite” is used herein to broadly refer to any flying platform, unless otherwise stated or required by context.

Rather than achieving pulse compression by transmitting and receiving frequency modulated RADAR pulses, such as “chirp” pulses, the disclosed system transmits fixed frequency, phase modulated RADAR energy, which avoids Range/Doppler ambiguities and enables both range and Doppler information to be extracted from the received signals and included when constructing a 3D reflectivity model of the imaged region, thereby reducing 3D reflectivity field ambiguities, even for complex distributed-target fields. In embodiments, the fixed-frequency RADAR energy is phase modulated according to a pseudo-random phase code that does not repeat during a period of at least 5 ms seconds, and in some embodiments does not repeat during a period of at least 1 second. In embodiments, the precipitation field is irradiated by a continuous frequency, pseudo-randomly phase shifted beam of RF emitted by the transmitting satellite(s) and received by a plurality of receiving satellites while the satellites are flying in the multi-static configuration, thereby avoiding Nyquist artifacts.

In addition, embodiments of the disclosed system apply an amplitude-based or a power-based incoherent modeling algorithm to the received signals to infer cross- track structure from the combined measurements of the receiving satellites. This approach reduces “Doppler smear” effects due to scattering center velocities, and allows the use of longer measurement windows, thereby improving the signal-to-background-noise ratio and reducing transmitter power requirements.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a multi-static formation of three-microsatellites according to an embodiment of the present disclosure;

FIG. 2A is a block diagram of a transmitter in an embodiment of the present disclosure;

FIG. 2B is a block diagram of a receiver in an embodiment of the present disclosure;

FIG. 3 is a flow diagram that illustrates a method embodiment of the present disclosure;

FIG. 4 is a graph that illustrates the location of a multi-static formation of three satellites at the beginning of each of a plurality of spotlight dwells during an overpass of an ROI;

FIG. 5A illustrates the relative locations of the formation of satellites and the ROI at the beginning of an early dwell during the overpass of FIG. 4;

FIG. 5B illustrates the relative locations of the formation of satellites and the ROI at the beginning of a middle dwell during the overpass of FIG. 4; and

FIG. 6 is a graph that details power fraction as a function of bin number according to the Gaussian Mixture Model as applied in embodiments of the present disclosure.

### DETAILED DESCRIPTION OF THE DISCLOSURE

The disclosed system and method implement synthetic aperture RADAR (SAR) using at least one high altitude transmitting platform and at least two high altitude receiving platforms, flying in a relatively fixed, “multi-static” formation at an altitude that is higher than the precipitation field. A mixture of coherent and non-coherent methods is employed to simulate an effectively large (e.g., 15 m in the Ku-band) aperture that provides, in embodiments, a horizontal resolution of 1 km or less and, in some embodiments, a vertical resolution of less than 125 m.

The term “precipitation field” is used herein to refer to any region of interest that contains “scattering centers,” which can include any combination of rain drops, snowflakes, hail, and/or sleet, as well as clouds, fields of dust particles, and/or blowing sand, among other scatters.

While the present disclosure is mainly described herein with reference to transmitting and observation satellites, which can be in low earth orbit (LEO), it will be understood that the present disclosure also applies to high-speed aircraft that are able to transmit and receive RADAR signals while traveling at an altitude that is higher than the precipitation field, for example at an angular velocity of at least 0.5 radians per minute. Accordingly, the term “satellite” is used herein to broadly refer to any platform that is traveling at an altitude that is higher than the precipitation field, unless otherwise stated or required by context.

Furthermore, while the disclosure herein sometimes refers to the satellites as “microsatellites,” it will be understood that the disclosed apparatus and method can be implement using any class of satellites, and that the term “microsatellite” is used herein to refer generically to any type of satellite, and indeed any type of flying platform, unless otherwise stated or required by context. Also, while embodiments of the present disclosure operate in the Ku band, it will be noted that in other embodiments the disclosed system and method operate in other RADAR bands, including the C, X, Ka, and W bands, depending on the strength of the back-scatter cross-section (which depends on frequency), as well as the available satellite resources, and the penetration depth that is required for a given storm type.

According to the present disclosure, the transmitting and receiving platforms function as a plurality of bi-static pairs of platforms, wherein each transmitting platform participates in a bi-static pair with at least one of the receiving platforms, and wherein each of the receiving platforms participates in a bi-static pair with at least one of the transmitting platforms.

Prior approaches include causing the transmitting satellite(s) to apply a series of frequency-modulated “chirp” RADAR pulses to the precipitation field. These prior approaches are unable to incorporate Doppler information when constructing a 3D reflectivity model of the precipitation field, due to ambiguities arising from scattering center motion. As a result, these prior approaches are subject to 3D reflectivity field ambiguities when they are applied to complex, distributed-target fields, due to difficulties in unambiguously assigning the received, reflected energy to the voxels within the volume being imaged.

According to these prior approaches, along-track scatterer positions are determined using an incoherent visibility method, while cross-track scatterer positions are determined using coherent range difference methods that require ultra-high-precision synchronization of the local oscillators of the receiving satellites, where the term “ultra-high-precision synchronization” refers herein to clock synchronization within 10 picoseconds, and preferably to within 5 picoseconds.

Furthermore, “Doppler smear” effects arising from movements of the scattering centers during the sampling window limit these prior approaches to very short sampling windows of less than 10 microseconds, thereby limiting the signal-to-background-noise ratio and increasing transmitter power requirements. Furthermore, attempting to increase the signal-to-background-noise ratio by increasing the RF pulsing rate can give rise to Nyquist ambiguities.

In contrast, the disclosed system and method can resolve the structure of severe storms while reducing complexity, transmitter power, and timing synchronization requirements, and minimizing or avoiding 3D reflectivity model. ambiguities, even for complex, distributed-target fields.

According to the present disclosure, the vertical field structure of the 3D reflectivity model is determined using range information, while the orbital velocity of the satellites is used to sweep out a synthetic aperture to determine the along-track horizontal field structure of the 3D reflectivity model. In embodiments, a high orbital velocity of the satellites relative to the precipitation field enables coherent SAR Range-Doppler imaging observation of the along-track field structure with finer than 1 km along-track resolution by the individual bi-static transmitter/receiver pairs of satellites.

The RADAR energy is transmitted by the disclosed system using constant frequency, phase modulated RF, rather than frequency modulated RF. Both range and Doppler information can be recovered from the received phase-shifted waveforms by applying the pulse compression demodulation using a reference waveform at the transmitted frequency, while also applying the pulse compression demodulation using reference waveforms that have been shifted in frequency from the transmission frequency. In embodiments, the phase shifting is pseudo-random, thereby enabling the received signals to be synchronized by aligning their pseudorandom phase shifts. In various embodiments, “Binary Phase Shift Keying” (BPSK) is applied to the transmitted RADAR signals. In embodiments, the phase of the RF can be modulated in a pseudo-random fashion.

The inclusion of Doppler information in the construction of the 3D reflectivity model improves the accuracy with which the received, reflected energy is assigned to voxels within the volume being imaged, and reduces 3D reflectivity field ambiguities, even in the presence of complex, distributed-target fields.

The SAR method as implemented herein for observing vertical and along-track structure provides high spatial precipitation field observations along those axes, but does not, by itself, resolve cross-track spatial structure. Instead of relying on phase-coherent processing of the inter-satellite data, embodiments of the disclosed system apply an incoherent amplitude or power model to combine the along-track/vertical 2D maps collected from a plurality of the bi-static pairs of satellites during the platform overpass of the precipitation field, and thereby to extract the cross-track structure.

In embodiments, the incoherent power model is a novel Gaussian Mixture Model (GMM) which, in embodiments, employs a power model to develop the 3D reflectivity map of the precipitation field, implicitly supporting a “tomographic” reconstruction technique by expressing the received power spectral densities of the numerous measurements of the plurality of satellites as a linear combination of the unknown reflectivity of the scattering centers multiplied by the calculated Radar Equation for the source of that reflection. The disclosed GMM method is described in more detail below.

It will be noted that the term “reflectivity map” is used herein to refer to a map of the reflectivity of a precipitation field expressed in conventional Cartesian coordinates, whereas the terms “tomography” and “tomographic map” refer to estimating the densities of the scattering centers on a per-voxel basis, where the voxels may not all be equally spaced or of equal size.

By including range/Doppler information, and by applying an incoherent analysis to obtain the cross-track structure, the disclosed method is rendered less sensitive to the “Doppler smearing” of range information caused by movement of the scattering centers during the observation windows. As a result, the sampling windows, also referred to herein as “coherent processing intervals” (CPI), can be made much longer than in previous approaches, in embodiments up to 100 ms, thereby reducing the effects of background noise and ground scatter with reduced signal power requirements.

In addition, due to the application of an incoherent analysis to obtain cross-track structure, the disclosed method does not require ultra-high precision time synchronization between the satellites. In embodiments, inter-satellite time synchronization on the order of 1-10 ns, for example using GPS technology, is sufficient.

In embodiments, the application of pseudo-random phase-modulated RF power enables Nyquist artifacts to be minimized or eliminated by implementing a very long pseudo-random modulation pattern. In some of these embodiments, the pseudo- random phase-modulated RF is applied continuously by the transmitting satellite(s), thereby increasing the rate of data acquisition while minimizing peak power requirements.

In embodiments of the present disclosure, the along-track mapping is not continuous along the satellite track. Instead, the satellite formation targets one or more discrete “regions of interest” (ROIs). For each of the ROIs, the satellite formation executes a coordinated “back-scan” maneuver after each CPI to repeatedly point their data collecting apertures at the ROI, thereby enabling an “observation” of the ROI to include a plurality of measurements of the ROI obtained during a plurality of CPIs while the observer effectively rotates around the target. According to this “spotlight mode” approach, the observation of the ROI can span an extended period of time, for example from several seconds to a few minutes or more. Instead of relying on a few, very high-power RF pulses, each of less than 10 microseconds duration, these embodiments rely on a larger number of lower-power measurements made during CPIs lasting, for example, for about 20 ms, during which period the precipitation field is effectively stationary. This synthetic aperture RADAR “spotlight” mode of observing one or more ROIs, as used in certain embodiments, is a natural fit for observing a precipitation field.

In embodiments, a total spotlight mode observation of an ROI having an observation time of several minutes allows the collection of multiple fields, as well as body steering between the fields in a step-stare fashion, and providing a total “field of regard” (FOR) of about 2500 km². In embodiments, the along-track spacing that separates the ROIs is on the order of 100 km.

It should be noted that the counter-coupling between orbital motion and illumination position that is characteristic of this “spotlight mode” SAR method, as used in certain embodiments of the present disclosure, has important implications for along-track resolution and sampling. The required spatial resolution depends directly on the integration angle, which depends on range (including orbit height). The effective angular rate depends on both orbital speed and orbit height. The required duration of each CPI is therefore given by the ratio of the required integration angle and the angular rate.

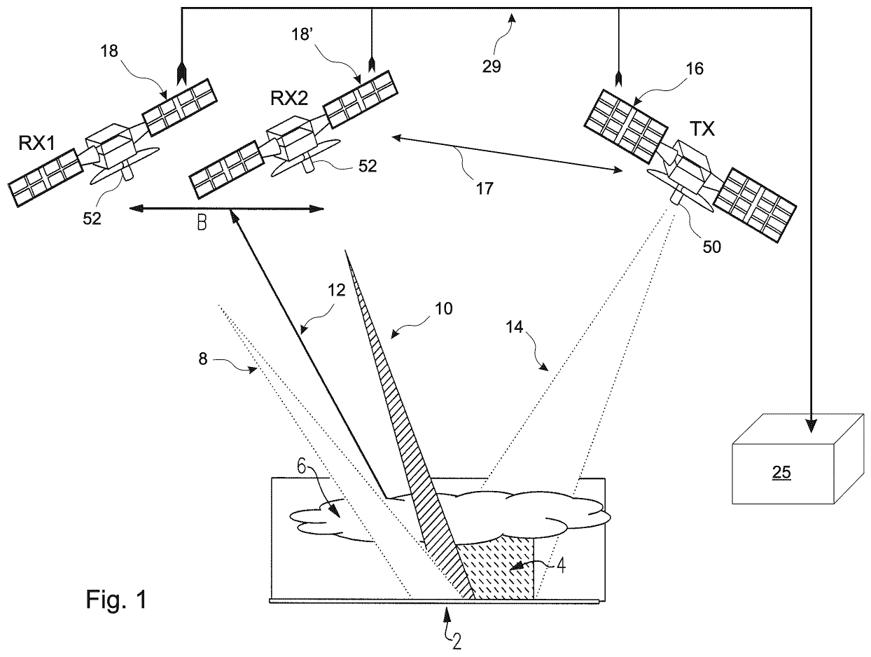

An exemplary embodiment of the present disclosure is illustrated in FIG. 1, in which the disclosed method is implemented by a cluster of three satellites 16, 18, 18′ moving in a multi-static formation in low-earth orbit, wherein the satellite cluster includes one transmitting satellite (TX) 16 and two receiving satellites (RX1 18 and RX2 18′).

In embodiments, at least one of the satellites 16, 18, 18′ can be transitioned between being a transmitting satellite and being a receiving satellite, thereby enabling both the number and positions of the TX and RX satellites to be varied. For example, in an embodiment of the present disclosure, one of the satellites functions as the TX satellite when the cluster is operating in the X band, while another of the satellites functions as the TX satellite when the cluster is operating in the Ku band.

The transmitting satellite 16 emits a fixed-frequency transmit beam 14 toward a storm 6, resulting in multiple received signals 8, 10 that are reflected from a portion of a backscattering precipitation field 4 created by the storm 6. The receivers RX1 18 and RX2 18′ apply a phase sensitive reception technique, such that the received signals 8, 10 are phase encoded. In embodiments, the transmit beam 14 is continuously transmitted and/or binary phase encoded, for example as pseudorandom “binary phase-shift keying” (BPSK) signals.

Waves emitted by a transmitting aperture 50 included in the transmitter satellite, TX 16, are scattered back to receiving apertures 52 included in the receiving satellites RX1 18, RX2 18′, with all of the receivers 18, 18′ operating at a frequency of interest. The locations of the region of interest 2 and the precipitation field 4 are shown in the figure. The range vector 12 is from the backscattering precipitation field 4 to the receiver-pair baseline vector, B.

Still referring to FIG. 1, the velocity vector of the satellite formation is out of plane of the figure. The along-track motion of the satellites enables separate 2D SAR “images” of along-track structure (range and along-track) to be derived from the signals received by each of the receiving satellites 18, 18′. These 2D SAR “images” are essentially projections of the scattering center intensities of the precipitation field onto a two-dimensional plane defined by the longitudinal (along track) and vertical directions.

The third “cross-track” dimension of the tomographic map is obtained by applying an incoherent amplitude or power model, such as the Gaussian Mixture Model (GMM) described below, to the 2D “images” to provide volumes (“voxels”) for use in the calculation of the full 3D tomographic map. Scattering center densities are assigned to each of the voxels, according to this approach. In embodiments, additional characteristics of the precipitation field 4 are assigned to each of the voxels, such as precipitation rates and/or other characteristics of the precipitation field 4. In some embodiments, the disclosed system is able to provide a tomographic map of a 240×10 km precipitation field 4 at a 1 km horizontal and ⅛ km vertical resolution.

One benefit of multi-static RADAR is that it allows observation of near-surface precipitation fields at positions that are significantly displaced from the transmitter's orbital track. While down-looking precipitation RADAR eventually will pass over a given region, selecting the region on an orbit-by orbit or day-by-day basis requires the ability to enable observation within hours of the cue. With reference again to FIG. 1, this capability can be enabled by agile receiver satellites (RX1, RX2) moving cross-track to adjust their angles with the transmitter satellite(s) (TX). At the appropriate TX/RX spacing, iso-range surfaces are nearly parallel to the ground, allowing ground-clutter-free returns close to the ground. This behavior is provided by the system of the present disclosure because a “de-ramp” function in the receiver de-modulates signals based on time-of-flight. A plurality of images over a plurality of coherent processing intervals (CPIs) are aggregated to increase SNR (and average over any speckle effects).

In embodiments, the two receivers, RX1 18 and RX2 18′, are separated by a baseline, B, that can be between 10 km and 1000 km in length, preferably between 10 km and 12 km in length, and are in orbit, together with the transmitter, TX 16, at an orbit height=H, with the satellites 16, 18, 18′ progressing along their respective orbits in the direction perpendicular to the plane of the figure at orbit velocity=v. While shown in almost identical horizontal alignment, the satellites would, in general, also have a variation in their elevations. Each of the two receivers, RX1 18 and RX2 18′, separately collects the backscattered radiation 8, 10 needed to reconstruct a 2D (Range-Doppler) SAR image of the precipitation field in which the spatial dimensions along the orbital track, and along the range axis, are resolved in the reconstructed 2D images, as discussed above, but where the spatial information perpendicular to these 2D images (approximately cross-track) is not resolved.

In embodiments, for each of the receiving satellites 18, 18′, at least one coherent 2D SAR image is formed from data collected during a brief “coherent processing interval” (CPI), which in embodiments is 100 ms or less. The CPI is chosen to be short enough so that the Doppler spread due to the velocity differences between the scattering centers does not degrade the image. As noted above, the currently disclosed method is significantly less affected by Doppler spread than previously disclosed methods.

In order to improve the signal to noise ratio, embodiments operate in a spotlight mode, as discussed above, in which a series of these coherent 2D SAR images are derived from data collected by each of the receiving satellites 18, 18′ within a series of coherent processing intervals (CPIs). Following Fourier transformation, in embodiments these coherent 2D SAR images are then incoherently added together to form an incoherent 2D (Range-Doppler) SAR image of the precipitation field for each of the receiving satellites 18, 18′. The cross-track structure of the 3D reflectivity model, which relies on data from both of the receivers RX1 18 and RX2 18′ to resolve the third-dimension, is derived from data collected during the entire period of the spotlight “observation,” since the applied amplitude or power model analysis is not degraded by the velocity spread of the scattering centers.

In one embodiment, the satellites each have transmitters and receivers that enable communication 17 between the transmitter 16 and the corresponding receivers 18, 18′. In various embodiments, the satellites 16, 18, 18′ communicate information which may include transmission parameters that provide to the receivers 18, 18′ a priori information regarding the transmit beam 14. Since the satellites 16, 18, 18′ in these embodiments have transmission and reception capability, in embodiments at least one of the satellites 16, 18, 18′ can be transitioned between being a transmitting satellite TX and being a receiving satellite RX, thereby enabling both the number and positions of the TX and RX satellites to be varied. For example, as noted above, in an embodiment of the present disclosure one of the satellites functions as the TX satellite when the cluster is operating in the X band, while another of the satellites functions as the TX satellite when the cluster is operating in the Ku band.

A processor group comprising one or more processors, also referred to herein as the “command center” 25, receives data transmitted 29 from the RX satellites 18, 18′, and in embodiments also from the TX satellite 16. In one example, the command center 25 is a terrestrial-based station. In another example the command center is airborne, being located, for example, in an aircraft, AUV, or satellite. In a further example, the command center 25 is co-located on at least one of the RX 16 or TX 18, 18′ satellites. In various embodiments, the command center 25 comprises a plurality of processors, which may be co-located or distributed in their locations. The command center 25 then processes and combines all of the 2D SAR images to form a 3D tomographic map, and ultimately a 3D reflectivity map, of the ROI, which is presented to one or more end users.

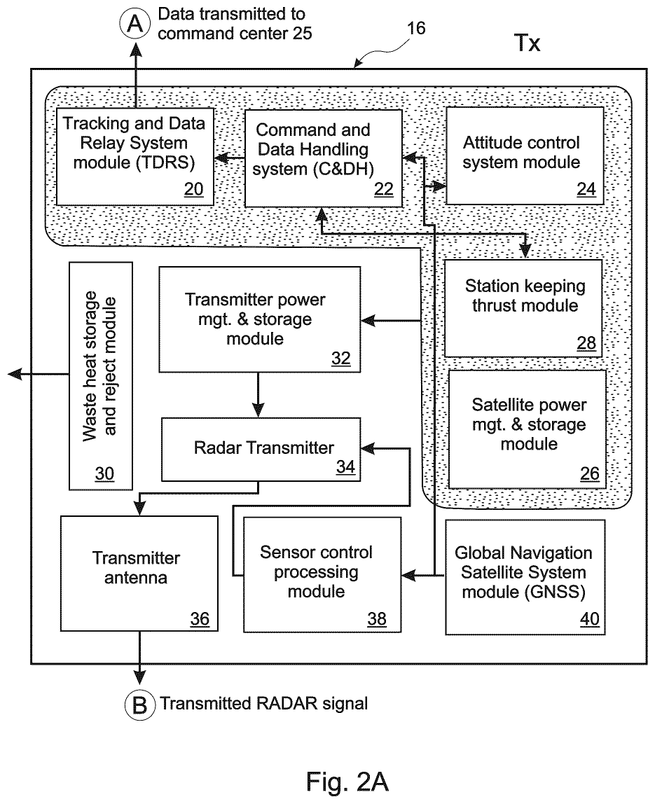

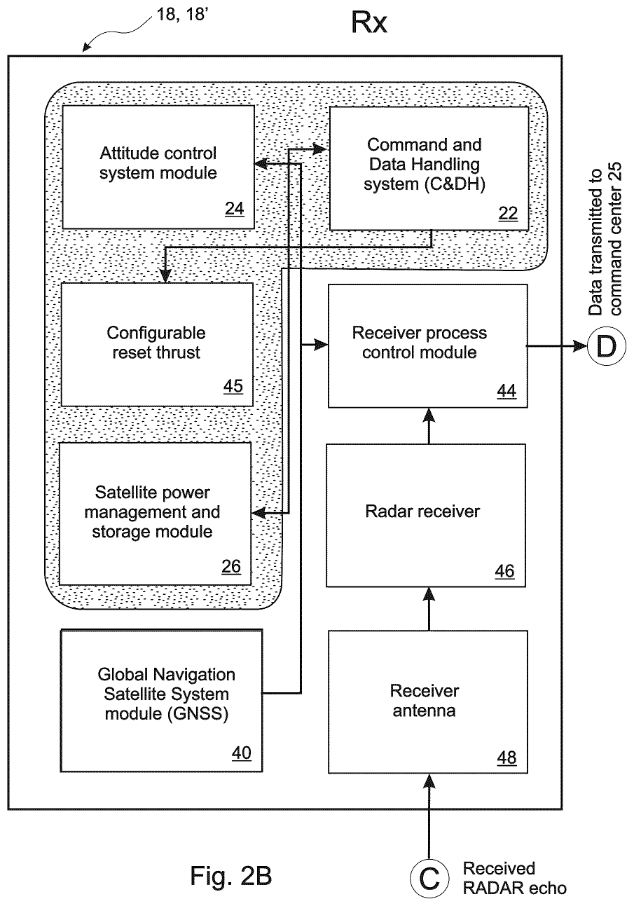

Referring to FIGS. 2A and 2B, block diagrams of one embodiment of a transmitter 16 (FIG. 2A) and one embodiment of a receiver 18, 18′ (FIG. 2B) are shown according to the principles of the present disclosure. The transmitter TX 16 transmits data A to the command center 25 and transmits RADAR signal B toward the ROI 2. RADAR signal B impacts the precipitation field 4 in the ROI 2 to produce scattered signals 8, 10 that are received C by the receivers RX 18, 18′. The receivers 18, 18′ transmit 29 the received signals D to the command center for analysis. The command center 25 in one embodiment uses the transmitter data 29 when processing the signals D received from the receivers 18, 18′ to create the 3D reflectivity map of the precipitation field 4, which is then communicated to the end users.

In the illustrated embodiment, a command and data handling system (C&DH) module 22 is present on each of both the transmitter 16 and receivers 18, 18′, as well as an attitude control system module, 24, and a satellite power management and storage module 26. Additionally, a Global Navigation Satellite System (GNSS) module 40 is present on both the transmitter 16 and each of the receivers 18, 18′. By way of example, the GNSS 40 can include any of the satellite constellations providing Position, Navigation and Timing (PNT), which include GPS, Galileo, GLONASS, BeiDou, QZSS, IRNSS, and Kuiper. In embodiments, the PTSS modules 40 communicate with each other via an RF link, or the like.

With reference to FIG. 2A, on the transmitter TX 16 there is also a communication system for interacting with a tracking and data relay satellite (TDRS) system 20 module, or the like, as well as a station-keeping thrust module 28 and a waste heat storage and reject module 30. Additionally, the transmitter TX 16 includes a transmitter power management and storage module 32. In the illustrated embodiment, the radar transmitter 34 operates in the Ku band, and the transmitter antenna 36 measures 2 m×0.5 m in size. In the illustrated embodiment, the radar transmitter 34 also communicates with a sensor control processing module 38.

With reference to FIG. 2B, on the receiver RX 18, 18′, there is a receiver process control module 44, a configurable reset thrust 45, and a radar receiver 46. In the illustrated embodiment, the radar receiver 46 operates in the Ku band, and the receiver antenna 48 measures 0.5 m in diameter.

Certain embodiments of the system of the present disclosure operate at RF frequencies in the 3-100 GHz range. The specific frequencies that are optimal for a weather RADAR application are influenced by the strength of the back-scatter cross-section (which depends on frequency), as well as the available satellite resources and the depth that is required to “see” into a given storm type. In some cases, using a Ku-band system is a reasonable choice, as Ku-band radiation can “see” through even intense storms, and can provide 3D imagery of acceptable image sizes and resolution, all while using microsatellites of reasonable size and reasonable orbits.

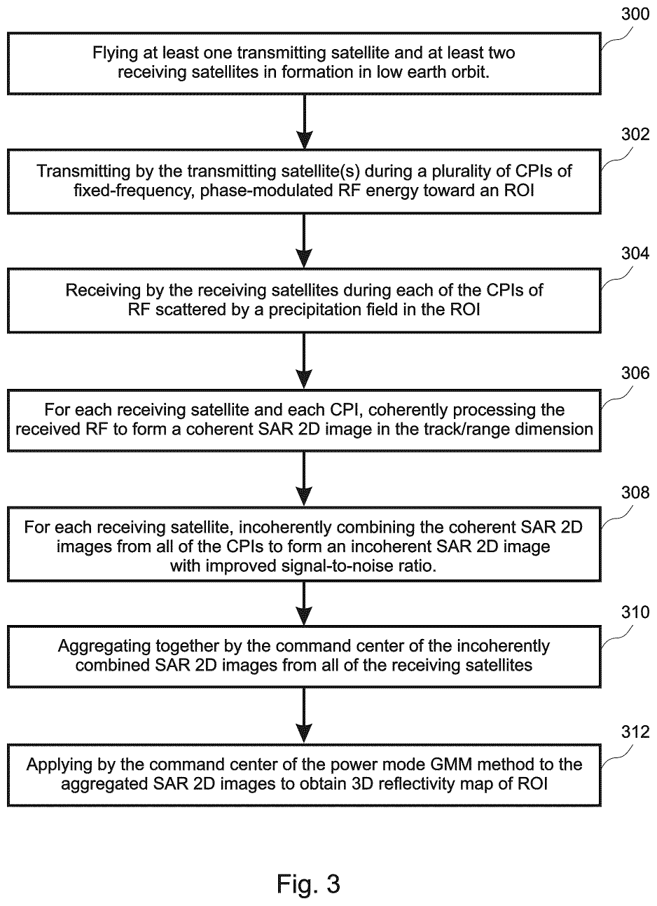

FIG. 3 is a flow diagram that illustrates a spotlight mode embodiment of the disclosed method of obtaining 3D high resolution reflectivity mapping of precipitation fields 4. With reference again also to FIG. 1, the embodiment illustrated by FIG. 3 includes flying 300 at least one transmitting satellite TX 16 and at least two receiving satellites RX 18, 18′ in formation in low earth orbit, and transmitting 302 by the at least one transmitting satellite TX 16 of RF energy as a transmit beam 14 at a fixed frequency. The transmit beam 14 in the illustrated example is transmitted in the Ku band and directed to the earth's surface 2, with the transmit beam 14 having a diameter that can measure in the range of 5 to 20 km. In one embodiment, the transmit beam 14 encounters a precipitation field 4, such that backscatter reflections 8, 10 from the precipitation field 4 are received 304 by each of the receivers RX 18, 18′. The transmitter TX 16 also communicates directly with the receivers RX 18, 18′ and/or with a command center 25 to provide properties of the transmitted signals.

The backscatter reflections from the precipitation field 4 are processed by the receiver chain, which may filter and amplify the signals before converting them from analog to digital signals. The digital signals that are received by each of the RX satellites 18, 18′ during each CPI are coherently processed by the command center 25 according to their amplitudes and phases to form 306 coherent SAR 2D images in the track/range dimension, as defined by the velocity vector of the satellites 16, 18, 18′ (constant altitude vector) and the vector that connects the satellites 16, 18, 18′ to the ROI 2 (downward sloping vector). The amplitudes of the coherent SAR 2D images are then incoherently combined 308, i.e. combined without reference to their phases, for each of the RX satellites 18, 18′ to form incoherent 2D SAR images having improved signal-to-background noise ratios. The method further includes incoherently aggregating together 310 by the command center 25 the incoherent 2D SAR images derived from signals received by all of the receiving satellites RX 18, 18′. An amplitude or power modeling method, such as the GMM method described below, is then applied by the command center 25 to the aggregated 2D SAR images to obtain a 3D tomographic map of the region of interest 312.

### Disclosure of the Gaussian Mixture Model Method

A detailed disclosure of the Gaussian Mixture Model (GMM) and its elements is presented below.

### Observation Model

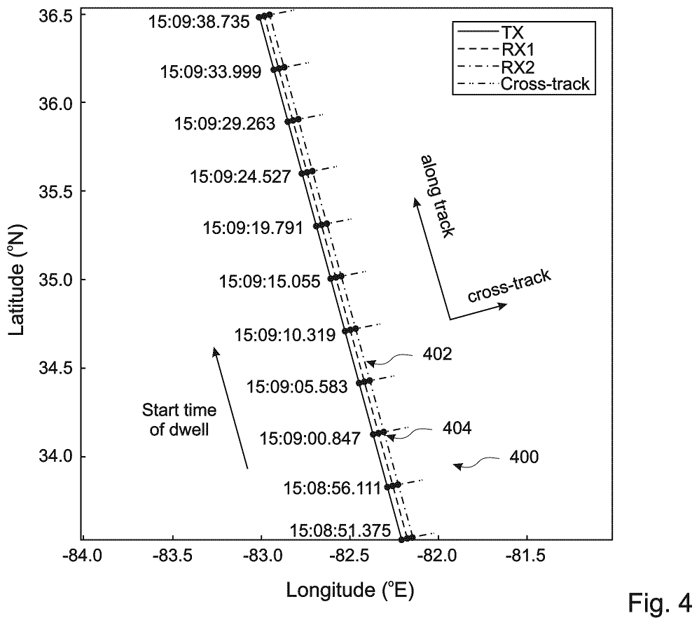

According to the “spotlight mode SAR” approach, as described above, with reference to FIGS. 1 and 4, the plurality of satellites TX 16, RX1 18, and RX2 18′ will execute an observation 400 during some portion of an overpass near the region of interest (ROI) 2, also referred to herein as the “field of regard” (FOR). During that observation 400, the system will collect at least one “dwell” of radar data, which in embodiments will result from incoherent combination of a plurality of coherent 2D SAR images obtained during a plurality of CPIs, as is described above with reference to FIG. 3. In the embodiment of FIG. 4, the observation includes a plurality of “dwells” 402 of radar data. FIG. 4 illustrates the location of the three satellites 404 at the beginning of each dwell 402.

Each dwell 402 will produce a (relative) range/Doppler grid of defined size. A separate range/Doppler grid is generated from the data obtained by each receiver, i.e. by each receiving satellite RX 18, 18′. The total collection of these dwells 402 for a given observation 400 can be expressed as a 4D matrix defined as (# of dwells)×(# of receivers)×(# of Doppler)×(# of range), which forms the “observation” that is used to estimate the storm reflectivity.

### Grid Definition

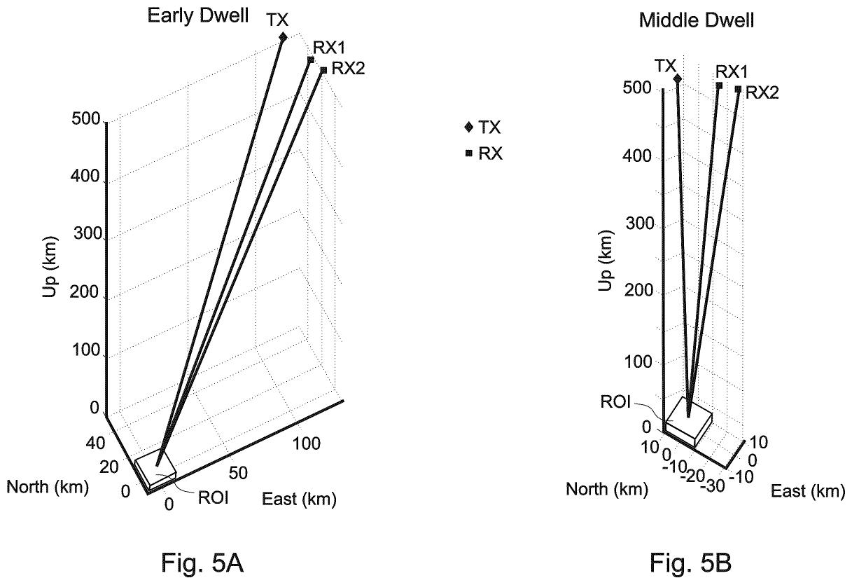

With reference to FIGS. 5A and 5B, a basic XYZ grid is defined that includes a substantially horizontal upper surface and a plurality of horizontal X-Y layers of altitude from zero to a defined maximum (e.g., 15 km). FIG. 5A illustrates the relative locations of the formation of satellites and the ROI at the beginning of an early dwell during an overpass, while FIG. 5B illustrates the relative locations of the formation of satellites and the ROI at the beginning of a “middle” dwell during the overpass.

In the illustrated embodiment, the XYZ grid is a “topocentric” Cartesian coordinate system having a reference point (0, 0, 0), and with axes X—East, Y—North, and Z—“up,” sometimes referred to as an “ENU” coordinate system. In the illustrated embodiment the XY plane is tangential to the earth's surface (horizontal to the ground), and the zero point is nominally located at the surface of the earth, such that the ground forms an X-Y plane along (X, Y, 0). The upper surface of the grid is chosen such that it is above any altitude at which significant precipitation is expected, for example above 15 km, because precipitating clouds rarely rise as high as 15 km. In the illustrated embodiment the satellites TX 16, RX1 18, RX2 18′ are flying in formation approximately 500 km above the earth's surface, and hence approximately 500 km above the X-Y plane.

The XYZ grid defines a plurality of “voxels” for which densities of precipitants will be estimated. In embodiments, the vertical “Z” step size is greater than the horizontal X and Y step sizes, such that the voxels are vertically extended rectangular prisms.

If off-specular modeling is desired, the grid can be given a non-zero center point. In embodiments, a spacing between the layers of altitude of 200 meters provides reasonable performance. In general, this spacing will depend on the radar system resolution. The Z step size can be different from the X and Y step size, which can also differ from each other, such that the nominal “voxel” is a rectangular prism.

### Storm Definition

A key aspect of the GMM method of the present disclosure, as compared to simple grids or other means of expressing the structure of a storm, is that it applies a “Radar Power Model” to the observations that depends only on the amplitude, or power, of the received radar signals. Another key aspect of the GMM method is that it leverages the concept of Gaussian mixtures. According to this approach, a storm is modeled as being the sum of a plurality of “cells,” corresponding to the voxels described above, which follow Gaussian (normal) functionals in multiple dimensions. Each cell in this model is taken to have a peak reflectivity at some voxel location (XYZ) in the storm zone, and is then assigned a vertical and horizontal extent factor:

$$Z ( x , y , z ) = {Z}_{max} {e}^{- \frac{1}{2} [ {( x - X )}^{2} + {( y - Y )}^{2} ] / {σ}_{H}^{2}} \times {e}^{- \frac{1}{2} [ {( z - Z )}^{2} ] / {σ}_{V}^{2}} \qquad ( 1 )$$

where σH and σV are parameters that define the relevant scale sizes (Horizontal, Vertical) of each “cell” of the Gaussian Mixture Model. In various embodiments, they are chosen deterministically using some knowledge of the storm, or in an iteration loop in the modeling. In other embodiments they are chosen as part of setting up a “convenient” grid to span the volume using a determined number of cells based on their spacing. For example, the inner cells can be spaced 1 km apart horizontally and 300 m apart vertically, while σH can be set equal to about 350 meters and σV can be set equal to 105 meters, thereby providing a smooth transition between adjacent cells.

The vertical and horizontal extents can be unique to each cell and can be derived, along with the positions, from the nonlinear cross-range resolution processing of the system.

### Clutter Model

While measurement of the reflections from the ground (ground clutter) is not an objective of this system, an accounting of these reflections must also be performed in order to make an accurate observation of the precipitation above the ground surface. A “beta model” is applied to the ground surface, (e.g. z=0 in the above grid definition) based on the angle β between the normal and the bistatic bisector. A non-uniformly spaced array of β values is created and a σ₀ value is assigned to each of them, where σ₀ represents the normalized radar cross section for each scattering scatterer. The values of σ₀ are taken as unknown, similar to the unknown Zmax values for the storm cells. The final fitting process then solves for these clutter reflectivities as needed. For a given surface patch, the calculation computes the bisector angle, and then assigns the power from that patch to come from the bin with the nearest value of β.

### Bistatic Radar Equations

The bistatic radar equation for a volumetric target is:

$${P}_{r} = \frac{{P}_{t} {λ}^{2}}{{( 4 π )}^{3}} {\sum }_{i} {η}_{i} \frac{{G}_{ti} {G}_{ri}}{{R}_{ti}^{2} {R}_{ri}^{2}} {V}_{i} , \qquad ( 2 )$$

where ηᵢ represents the volumetric cross section of the target, Pₜ is transmitted power, Pᵣ is received power, Gₜ is transmitter antenna gain, Gᵣ is receiver antenna gain, Rₜ is the range from the transmitter to the reflector in question (e.g., voxel in the target field), Rᵣ is the range from that reflector back to the receiver, and λ is the radar wavelength. The index i refers to a summation of responses from a large number of volume elements.

For precipitation like rain and ice, the standard formula for the volumetric cross section is

$${η}_{i} = \frac{{π}^{5} {\vert K \vert}^{2}}{{λ}^{4}} Z ,$$

where Z is typically quoted in 10*log10(mm⁶/m³). K is the dielectric constant of water or ice. The standard value is |K|²=0.93 for water. The value of Z is from the storm model described above. The volume is the size of the rectangle in the grid model. Using this, we can compute the incremental power from each volume element of the simulation grid.

The surface return uses a similar model using the normalized radar cross section (RCS) of the ground area:

$${P}_{r} = \frac{{P}_{t} {λ}^{2}}{{( 4 π )}^{3}} {\sum }_{i} {σ}_{0 i} \frac{{G}_{t i} {G}_{r i}}{{R}_{t i}^{2} {R}_{r i}^{2}} {A}_{i} , \qquad ( 3 )$$

where the area is the size of each grid square, and the clutter RCS is from the bistatic bisector model in units of dB(m₂/m₂).

### Power Allocation to Range/Doppler Grid

The formulae presented above enable computation of the power received from a given surface or volume element (voxel). It remains to accurately apportion the received radar power to the range/Doppler grid that is created by the radar processing.

In general with precipitation, there will be a velocity dispersion of the reflectors within each voxel. This dispersion may exceed the Doppler resolution, and may thereby spread the received power to multiple Doppler cells. Accordingly, the GMM model includes calculating a root-mean-square (RMS) deviation in range and Doppler for each voxel. One of the factors to be considered is the RMS range rate spread (velocity spread) ORR of the precipitation in the cell (voxel), which is used herein to describe the amount of turbulence (velocity spread) that is inherent in the rain itself. This turbulence will likewise “smear” the Doppler return from a voxel of rain.

A bulk velocity vector can also be given, which will adjust the Doppler shift of the cell returns beyond just the normal position-based shift from the satellites motion. That range and Doppler spread is then divided by the range and Doppler bin resolutions respectively to give a scaled spreading factor.

$${σ}_{F} = \sqrt{{( {σ}_{R R} / λ )}^{2} + {( 1.2 * Δ F )}^{2}} {σ}_{R} = \sqrt{{( Δ {Z}_{g r i d} )}^{2} + {( 1.2 * Δ R )}^{2}} \qquad ( 4 )$$

Here, the terms ΔF and ΔR are the Doppler and range resolutions respectively. The factor 1.2 is chosen somewhat arbitrarily but is consistent with typical processing roll-off. The Z grid step size is added to the range spreading because the vertical dimension will most strongly drive the relative range and therefore the finite size of the volume element (voxel) will cause some spreading of the return in the range dimension.

The parameters σ_{F} and σ_{R} express the fact that, because of both the physical nature of a volume scatterer and the nature of filtering in real RF systems (i.e. “not a brick wall”), all of the energy reflected by any single voxel should not be deposited into only the one range/Doppler cell whose center point is nearest to the range/Doppler of the voxel. Instead, a Gaussian spread function is used.

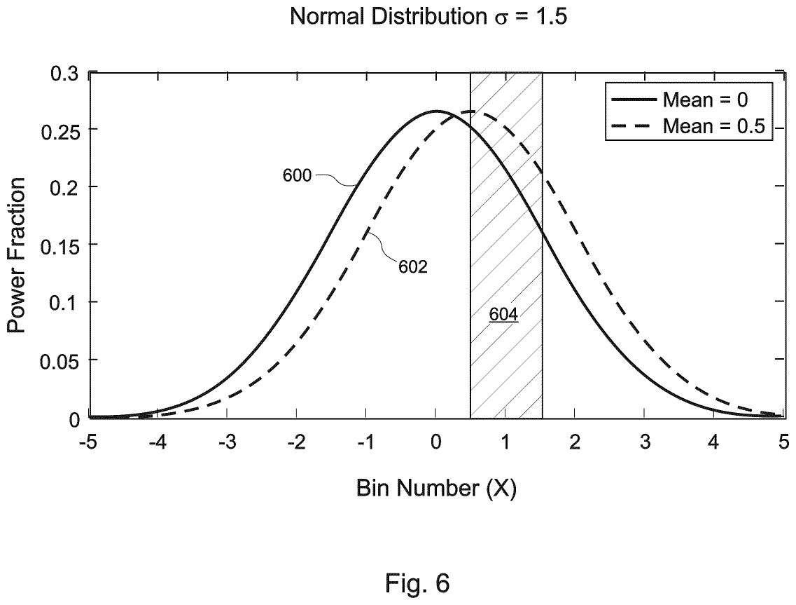

The power allocations as functions of range and Doppler difference are normal Gaussian functional distributions across their respective axes. It remains to find the integral of those along the number lines corresponding to each of the range/Doppler bin numbers. The distribution will be centered at the nominal range/Doppler shift that is mapped onto the bin numbers. Each bin gets the integral from ±0.5 around its number, as illustrated in FIG. 6.

FIG. 6 shows two examples of possible mean values 600, 602 that will have noticeable effects on the integral in the shaded region 604. The exact values of that integral can be calculated using the “Error function” (erf)

$$erf ( x ) = \frac{2}{\sqrt{π}} {\int }_{0}^{x} {e}^{- {t}^{2}} dt \qquad ( 5 )$$

If Δσ is used to denote the ratio of the step size (delta) to the RMS (sigma), our integral runs from (n−0.5) to (n+0.5):

$$F ( n ) = \frac{1}{2} [ erf ( \frac{( n + 0.5 ) Δσ}{\sqrt{2}} ) - erf ( \frac{( n - 0.5 ) Δσ}{\sqrt{2}} ) ] \qquad ( 7 )$$

Since calculating the function of eqn. 7 for every point in the field of regard would be computationally expensive, a 2-D Look-Up Table (LUT) is constructed in some embodiments. One dimension of the LUT corresponds to each bin offset out to a defined limit, which in embodiments is 5 standard deviations. The other dimension includes 11 possible values (−0.5, −0.4 . . . , 0.5) of the fractional offset. Beyond the defined limit of deviations, the function is flat enough to treat it as a constant over the interval. Accordingly, an exponential is used in this embodiment, and the bin width is one in this scaled integral. The ratio Ao is typically less than 1/1.2=0.83. Smaller values imply broader distributions which have even less influence on the change in the function over a unit interval. In embodiments, if Δσ is below 0.167, the table is truncated to ±30 bins.

### Numeric Integration

According to the disclosed GMM method, a numeric integration is performed to sum up the total power from each storm cell (or ground clutter) to derive the total received power Pₜₒₜₐₗ in each range/Doppler resolution cell:

$${P}_{total} ( {i}_{D o p p l e r} , {j}_{R a n g e} ) = {P}_{s k y} ( i , j ) + {P}_{clutter} ( i , j ) + {P}_{n o i s e} ( i , j ) \qquad ( 8 )$$

The noise power is assumed to be constant for every dwell and range/Doppler cell. The most important term is the sky return, which according to the formulas presented above is equal to:

$${P}_{sky} ( i , j ) = \frac{{P}_{𝔱} {λ}^{2}}{{( 4 π )}^{3}} {\sum }_{c e l l s} {Z}_{max ( cell )} \int \int \int dxdydz {e}^{- \frac{1}{2} [ {( x - {X}_{cell} )}^{2} + {( y - {Y}_{cell} )}^{2} ] / {σ}_{H}^{2}} \times {e}^{- \frac{1}{2} [ {( z - {Z}_{cell} )}^{2} ] / {σ}_{V}^{2}} \frac{{G}_{𝔱} {G}_{r}}{{R}_{𝔱}^{2} {R}_{r}^{2}} {f}_{Doppler} ( i ; x , y , z ) {g}_{Range} ( j ; x , y , z ) \qquad ( 9 )$$

where Pₜ is the radar transmitter power. A typical value of Pₜ would be 100 W.

The f_{Doppler} and g_{Range} functions in eqn. 9 represent the power allocation process described above. A similar process is applied for the ground clutter, where the unknown terms are the σ0 value for each β bin. Accordingly, the total power equation becomes:

$${P}_{total} ( i , j ) = {\sum }_{c e l l s} {Z}_{max ( cell )} A ( cell , i , j ) + {\sum }_{β bins} {σ}_{b i n}^{0} B ( bin , i , j ) + {P}_{noise} ( i , j ) \qquad ( 10 )$$

These “observation factor” matrices A and B are computed for every dwell, receiver, and range/Doppler bin, generating 5-dimensional matrices.

### Linear Solution Processing

Solving the matrix equations for A and B given a set of Ptotal measurements, the four dimensions of dwell, receiver, range, and Doppler can be collapsed to one as these can be treated as independent measurements. The matrices then become two-dimensional matrices representing the “observation factors” and a one-dimensional vector of power measurements.

While these matrix equations are linear, one of skill in the art of statistics and data fitting will understand that the statistical properties of the measurements will require care in the selection of an appropriate Maximum Likelihood estimation algorithm.

### Iterative Solution Improvement

The non-linear parameters (position, size, velocity vector and dispersion) of the Gaussian storm cells are held fixed for a given model run. In embodiments, the linear solution processing provides a measure of the quality of the estimates for each Zmax value and other global characteristics like distributions of the residuals as a function of time and range/Doppler. These can be used, either manually or algorithmically, to improve the nonlinear parameters of the cell model. In embodiments, the equations are transformed into the logarithmic (decibel) domain, so as to cause the statistics to be more favorable to the use of a Least Squares estimation algorithm, while maintaining an analytic, closed-form expression for the Jacobian matrix.

### Final Product(s)

If a volumetric description of the reflectance is desired, it can be extracted from the GMM model, by recognizing that the total reflectance is the sum over the cells:

$$Z ( x , y , z ) = {\sum }_{c e l l s} {Z}_{max ( cell )} {e}^{- \frac{1}{2} [ {( x - {X}_{c e l l} )}^{2} + {( y - {Y}_{c e l l} )}^{2} ] / {σ}_{H}^{2}} \times {e}^{- \frac{1}{2} [ {( z - {Z}_{c e l l} )}^{2} ] / {σ}_{V}^{2}} \qquad ( 11 )$$

### Additional Remarks

The foregoing description of the embodiments of the disclosure has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the disclosure to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well- understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one clement selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the disclosure. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A system for determining a three-dimensional (3D) reflectivity map of a precipitation field in a region of interest (ROI), the system comprising:
a plurality of platforms configured to fly in a multi-static formation at an altitude that is higher than an altitude of the precipitation field, the plurality of platforms comprising a first transmitting platform, and first and second receiving platforms, the first transmitting platform being configured to participate in a first bi-static pair with the first receiving platform, and to participate in a second bi-static pair with the second receiving platform; and
a processor group comprising at least one processor;
wherein:
the first transmitting platform is configured, while flying in the multi- static configuration, to transmit a phase-encoded RADAR waveform at a constant transmission frequency toward the ROI, the constant frequency, phase-encoded waveform being reflected by the precipitation field, thereby creating first and second reflected signals;
the first receiving platform is configured to receive the first reflected signal during a first coherent processing interval (CPI), and the second receiving platform is configured to receive the second reflected signal during the first coherent processing interval (CPI);
the processor group is configured to form a first two-dimensional (2D) vertical and along-track scanning aperture radar (SAR) image of the precipitation field according to range and Doppler information extracted from the first reflected signal;
the processor group is configured to form a second 2D vertical and along-track SAR image of the precipitation field according to range and Doppler information extracted from the second reflected signal; and
the processor group is configured to determine a 3D reflectivity map of the precipitation field according to the first and second 2D vertical and along-track SAR images.

2. The system of claim 1, wherein determining the 3D reflectivity map comprises applying an amplitude-based or a power-based incoherent modeling algorithm to the first and second 2D vertical and along-track SAR images.

3. The system of claim 2, wherein determining the 3D reflectivity map comprises:
dividing the ROI into a plurality of voxels;
for each of the voxels, computing a backscattered RF power; and
interpreting each of the backscattered RF powers as a sum of contributions from scattering centers located in the voxel.

4. The system of claim 3, wherein applying the amplitude-based or power-based incoherent modeling algorithm comprises determining coefficients which relate the backscattered RF amplitude or power for each of the voxels to a reflectivity for each of a plurality of model elements in a 3D reflectivity field model using a non-linear least-squares process.

5. The system of claim 3, wherein applying the amplitude-based or power-based incoherent modeling algorithm comprises, for each reflectivity element in the 3D reflectivity map, determining coefficients which relate amplitude or power elements in the first and second vertical and along-track 2D SAR images to the reflectivity element using a non-linear least-squares process.

6. The system of claim 2, wherein the power-based incoherent modeling algorithm is a Gaussian Mixture Model.

7. The system of claim 1, wherein the platforms are orbiting satellites.

8. The system of claim 1, wherein the constant frequency, phase-encoded waveform is phase modulated according to a pseudo-random phase code that does not repeat during a period of at least 5 ms.

9. The system of claim 1, wherein the constant frequency, phase-encoded waveform is phase modulated according to a pseudo-random phase code that does not repeat during a period of at least 1 second.

10. The system of claim 1, wherein:
the transmitting and receiving platforms are configured to implement a spotlight mode in which the first CPI is a first of a successive plurality of CPIs during each of which the first transmitting platform and the first and second receiving platforms are pointed at the ROI; and
the transmitting and receiving platforms compensate between the CPIs for their movement relative to the ROI by executing coordinated “back-scan” maneuvers that maintain the pointing of the transmitting and receiving platforms at the ROI.

11. The system of claim 10, wherein:
the first 2D vertical and along-track SAR image is a first incoherent 2D SAR image formed by incoherently combining a first plurality of coherent 2D SAR images derived from measurements made by the first receiving platform during the successive plurality of CPIs; and
the second 2D vertical and along-track SAR image is a second incoherent 2D SAR image formed by incoherently combining a second plurality of coherent 2D SAR images derived from measurements made by the second receiving platform during the successive plurality of CPIs.

12. The system of claim 1, wherein extracting the range and Doppler information from the first and second reflected signals comprises applying thereto a pulse compression demodulation using a reference waveform at the transmission frequency, while also applying pulse compression demodulations thereto using reference waveforms that have been shifted in frequency from the transmission frequency.

13. The system of claim 1, wherein a timing synchronization of 10 ns between internal time bases of the receiving platforms is sufficient for forming the 3D reflectivity map.

14. A computer program product including one or more non-transitory machine-readable mediums encoded with instructions that when executed by one or more processors cause a process to be carried out for satellite tomography of a precipitation field via a synthetic aperture radar, the process comprising:
transmitting by a transmitting platform, while flying in a multi-static configuration, a phase-encoded RADAR waveform at a constant transmission frequency toward a region of interest (ROI), the constant frequency, phase-encoded waveform being reflected by the precipitation field, thereby creating first and second reflected signals;
receiving by a first receiving platform during a first coherent processing interval (CPI), while flying in the multi-static configuration, the first reflected signal, and receiving by a second receiving platform during the first coherent processing interval (CPI), while flying in the multi-static configuration, the second reflected signal;
forming a first two-dimensional (2D) vertical and along-track scanning aperture radar (SAR) image of the precipitation field according to range and Doppler information extracted from the first reflected signal;
forming a second two-dimensional (2D) vertical and along-track range/Doppler SAR image of the precipitation field according to range and Doppler information extracted from the second reflected signal; and
determining a 3D reflectivity map of the precipitation field according to the first and second 2D vertical and along-track SAR images.

15. The computer program product of claim 14, wherein determining the 3D reflectivity map comprises applying an amplitude-based or a power-based incoherent modeling algorithm to the first and second 2D vertical and along-track images.

16. The computer program product of claim 15, wherein the incoherent modeling algorithm is a Gaussian Mixture Model.

17. The computer program product of claim 14, wherein the instructions are configured to cause the constant frequency, phase-encoded waveform to be phase modulated according to a pseudo-random phase code that does not repeat during a period of at least 5 seconds.

18. The computer program product of claim 14, wherein the instructions are configured to cause the platforms to implement a spotlight mode, wherein the first CPI is a first of a successive plurality of CPIs during each of which the first transmitting platform and the first and second receiving platforms are pointed at the ROI, and wherein the steps further comprise:
for each of the CPIs, receiving by the first and second receiving platforms during the CPI corresponding first and second reflected signals; and
compensating by the first transmitting platform and the first and second receiving platforms for their movement between the CPIs relative to the ROI by executing coordinated “back-scan” maneuvers between the CPIs that maintain the pointing of the transmitting and receiving platforms at the ROI.

19. The computer program product of claim 18, further comprising:
for each of the CPIs, forming coherent first and second 2D vertical and along-track SAR images of the precipitation field according to range and Doppler information extracted respectively from the first and second reflected signals;
forming the first 2D vertical and along-track SAR image by incoherently combining together all of the coherent first 2D SAR vertical and along-track SAR images; and
forming the second 2D vertical and along-track image by incoherently combining together all of the coherent second 2D SAR vertical and along-track SAR images.

20. The computer program product of claim 14, wherein determining the 3D reflectivity map comprises recovering both range and Doppler information from the first and second received signals by applying thereto a pulse compression demodulation using a reference waveform at the transmission frequency, while also applying thereto pulse compression demodulations using reference waveforms that have been shifted in frequency from the transmission frequency.
